(19) United States
(12) Patent Application Publication
(10) Pub. No.: US 2013/0088877 A1
(43) Pub. Date: Apr. 11, 2013

(54) LIGHTING DEVICE AND COMPONENT

(71) Applicants: Han-Chung Hsu, Luzhu Township (TW); Cheng-Chun Liao, Hsinchu City (TW); Chia-Shen Cheng, Taichung City (TW)

(72) Inventors: Han-Chung Hsu, Luzhu Township (TW); Cheng-Chun Liao, Hsinchu City (TW); Chia-Shen Cheng, Taichung City (TW)

(73) Assignee: LEXTAR ELECTRONICS CORPORATION, Hsinchu (TW)

(21) Appl. No.: 13/488,996

(22) Filed: Jun. 5, 2012

Related U.S. Application Data
(60) Provisional application No. 61/545,093, filed on Oct. 7, 2011.

(51) Int. Cl. F21V 13/04; F21V 5/00; F21V 7/04

(52) U.S. Cl. 362/309; 362/296.07; 362/311.02

(57) ABSTRACT

A light device and a lighting component are provided. The lighting device comprises a LED module and a lighting component. The LED module has an exposed light emitting surface. The lighting component covers the LED module and has an inputting surface and a top outputting surface. The inputting surface faces the light emitting surface of the LED module, the top outputting surface has a concave structure, and the concave structure is located opposite the light emitting surface.

This application claims the benefit of U.S. provisional application Ser. No. 61/545,093, filed Oct. 7, 2011, the subject matter of which is incorporated herein by reference.

### BACKGROUND

1. Field of the Invention

The disclosure relates in general to a lighting device and a lighting component, and more particularly to a lighting device and a lighting component having a concave structure.

2. Description of the Related Art

Along with the development in lighting technology, varied new lighting elements are invented. For example, light-emitting diodes, halogen lamps and laser diodes are new lighting elements.

According to varied material characteristics and lighting manners, the lift, the color and the emitting range of the light elements are different.

Taken the light-emitting diode (LED) as an example, the lift thereof is long, the power consumption thereof is low and the emitting range thereof is narrow. Due to the characteristic of long lift and low power consumption, LED makes progress in lighting technology. However, narrow emitting range of LED becomes a bottleneck of the development in lighting technology. Researchers are devoted to the study of this issue.

### SUMMARY

The disclosure is directed to a lighting device and a lighting component, which applies a concave structure to make the light device emitting an omnidirectional light for the need in lighting.

According to a first aspect of the present disclosure, a light device is provided. The lighting device comprises a LED module and a lighting component. The LED module has an exposed light emitting surface. The lighting component covers the LED module and has an inputting surface and a top outputting surface. The inputting surface faces the light emitting surface of the LED module, the top outputting surface has a concave structure, and the concave structure is located opposite the light emitting surface.

According to a second aspect of the present disclosure, a lighting component is provided. The lighting component comprises an inputting surface, a top outputting surface and a lateral outputting surface. The inputting surface faces a light emitting surface of a light source. The top outputting surface has a concave structure. The concave structure is located opposite the light emitting surface. The lateral outputting surface is located between the inputting surface and the top outputting surface. A cross-section of the top outputting surface substantially satisfies an equation: Y=7.984×10⁻⁷X⁶−8.093×10⁻⁵X⁵+3.185×10⁻³X⁴5.988×10⁻²X³+4.845×10⁻¹X²+2.520×10⁻¹X. A lowest point of the concave structure is an origin of a X-Y coordinate system. Y is a variable of a vertical axis. X is another variable of a horizontal axis. 0≦X≦15H. H is a unit of length.

The above and other aspects of the disclosure will become better understood with regard to the following detailed description of the non-limiting embodiment. The following description is made with reference to the accompanying drawings.

### BRIEF DESCRIPTION OF THE DRAWINGS

FIG. 1 shows a lighting device according to an embodiment;

FIG. 2 shows an exploded view of the lighting device of FIG. 1;

FIG. 3 shows a top view of the lighting device of FIG. 1;

FIG. 4. shows a cross-sectional view along the cross-sectional line 4-4 of some elements of the lighting device of FIG. 3;

FIG. 5 shows a side view of a lighting component of the lighting device of FIG. 1; and

FIG. 6 shows a back view of the lighting component of the lighting device of FIG. 1.

### DETAILED DESCRIPTION

Preferred embodiments are disclosed below for elaborating the invention. A concave structure is used in a lighting device to emit an omnidirectional light for the need in lighting. However, the following embodiments are for the purpose of elaboration only, not for limiting the scope of protection of the invention. Besides, secondary elements are omitted in the following embodiments to highlight the technical features of the invention.

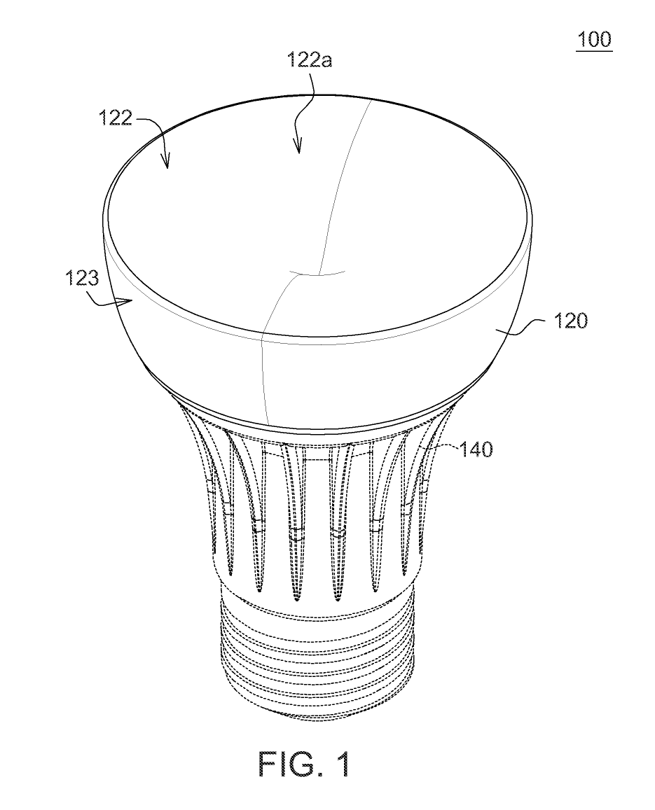

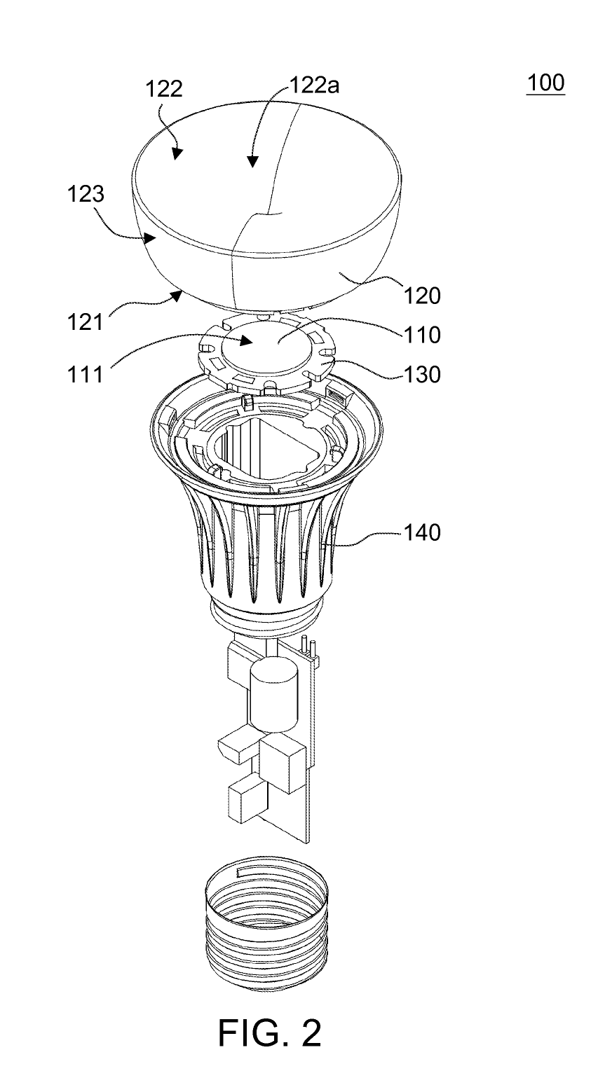

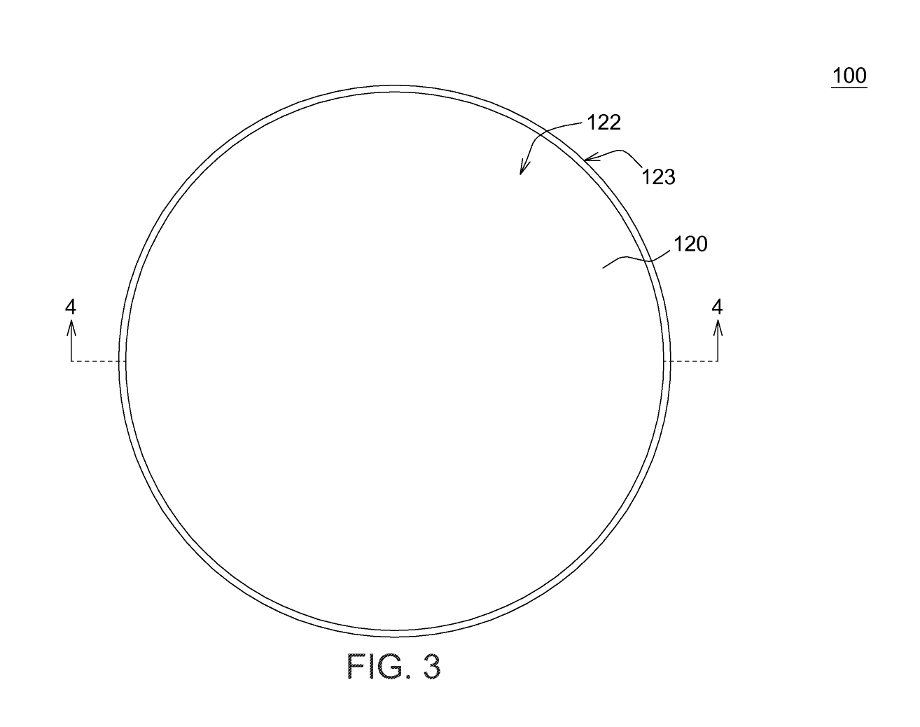

Please refer to FIGS. 1 to 3. FIG. 1 shows a lighting device 100 according to an embodiment. FIG. 2 shows an exploded view of the lighting device 100 of FIG. 1. FIG. 3 shows a top view of the lighting device 100 of FIG. 1. The lighting device 1010 comprises a light emitting diode (LED) module 110, a lighting component 120 and a circuit board 130. The LED module 110 is used for emitting a light. The lighting component 120 is used for guiding the light emitted from the LED module 110. The circuit board is used for disposing the LED module 110. In another embodiment, the lighting component 120 can be applied to other kinds of lighting sources. The lighting component 120 is not limited to be applied to the LED module 110.

As shown in FIG. 2, the LED module 110 has an exposed light emitting surface 111. The lighting component 120 covers the LED module 110. The lighting component 120 has an inputting surface 121, a top outputting surface 122 and a lateral outputting surface 123. The inputting surface 121 faces the light emitting surface 111 of the LED module 110. The inputting surface 121 is substantially a flat plane and is for receiving the light emitting from the LED module 110. The top outputting surface 122 has a concave structure 122a. The concave structure 122a is located opposite the light emitting surface 111. The lateral outputting surface 123 is located between the top outputting surface 122 and the inputting surface 121 and is used for refracting the light reflected from the top outputting surface 122.

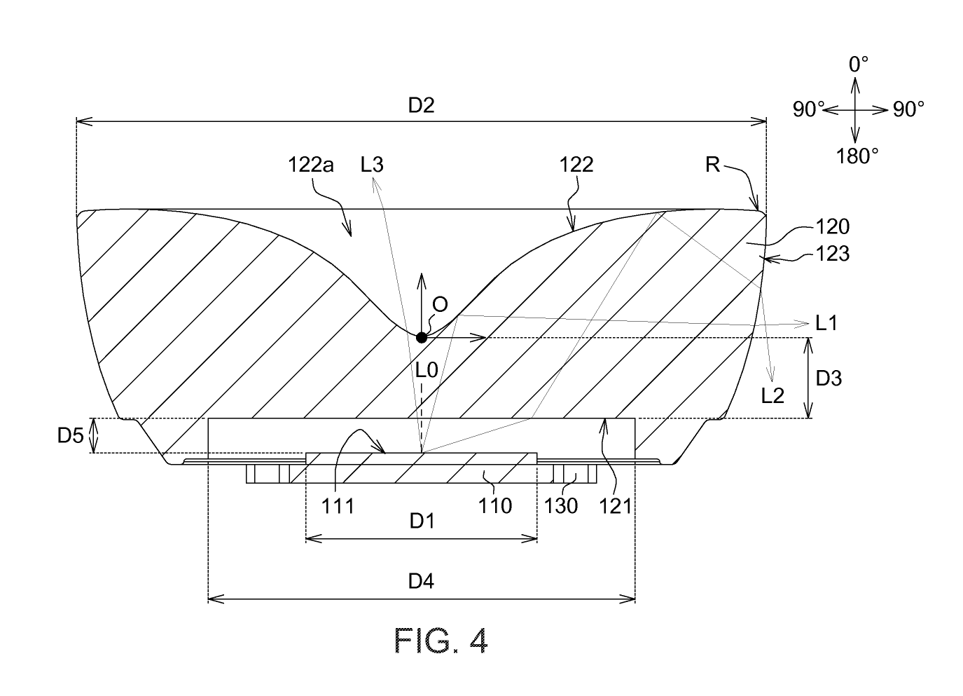

The top outputting surface 122 having the concave structure 122a can refract or reflect the light entering the lighting component 120 through the inputting surface 121. Please referring to FIG. 4, FIG. 4 shows a cross-sectional view along the cross-sectional line 4-4 of some elements of the lighting device 100 of FIG. 3. In the present embodiment, a cross-section of the top outputting surface 122 substantially satisfies an equation:

Y=7.984×10−7X6−8.093×10−5X5+3.185×10−3X4−5.988×10−2X3+4.845×10−1X2+2.520×10−1X (1)

A lowest point of the concave structure 122a is an origin of a X-Y coordinate system. Y is a variable of a vertical axis. X is another variable of a horizontal axis. 0≦X≦15H. H is a unit of length. If H is changed, then X and Y are changed in a corresponding ratio. The material of the lighting component 120 is glass, acryl or plastic for example. The critical angle of total reflection between the lighting component 120 and the air is 39.1 degrees for example.

Due to the designed equation, the LED module 110 has at least three kinds of light paths L1, L2 and L3. The angle between the beginning of the light path L1 and a light axis L0 of the LED module 110 is 15 degrees. The light path L1 is refracted through the inputting surface 121 and reaches the top outputting surface 122. Because the incident angle of the light path L1 is larger than the critical angle of total reflection, a total reflection happens while the light path L1 reaches the top outputting surface 122. After the light path L1 reaches the lateral outputting surface 123 and is refracted to outside of the lighting component 120, the outputting angle of the light path L1 is 90 degrees.

The angle between the beginning of the light path L2 and the light axis L0 of the LED module 110 is 55 degrees. The light path L2 is refracted through the inputting surface 121 and reaches the top outputting surface 122. Because the incident angle of the light path L2 is larger than the critical angle of total reflection, a total reflection happens while the light path L2 reaches the top outputting surface 122. After the light path L2 reaches the lateral outputting surface 123 and is refracted to outside of the lighting component 120, the outputting angle of the light path L2 is 150 degrees.

The angle between the beginning of the light path L3 and the light axis L0 of the LED module 110 is 2 degrees. The light path L3 is refracted through the inputting surface 121 and reaches the top outputting surface 122. Because the incident angle of the light path L3 is less than the critical angle of total reflection, the light path L3 is directly refracted to outside of the lighting component 120. The outputting angle of the light path L3 is 5 degrees.

As above, the outputting angle of the light path L3 is 5 degrees, the outputting angle of the light path L1 is 90 degrees and the outputting angle of the light path L2 is 150 degrees. After being refracted and reflected by the lighting component 120, varied light paths can have varied outputting angles.

Therefore, the outputting angles of the lighting device 100 can be ranged from 0 to 180 degrees.

Regarding the size of the LED module 110, if the size of the LED module 110 is changed, then the proportion between the light paths L1, L2 and L3 will be changed. In the present embodiment, the LED module 110 is circle-shaped and a diameter D1 of the LED module is 9H.

Regarding the size of the top outputting surface 122, if the size of the top outputting surface 122 is changed, then the proportion between the light paths L1, L2 and L3 will be changed. A projection of the top outputting surface 122 toward the inputting surface 121 is circle-shaped and a diameter D2 of the projection is 30H.

Regarding a distance D3 between the top outputting surface 122 and the inputting surface 121, the distance D3 between the top outputting surface 122 and the inputting surface 121 will change the position where the light reaches the top outputting surface 122 and therefore results in refraction or total reflection. In the present embodiment, the distance D3 between the lowest point of the concave structure 122a of the top outputting surface 122 and the inputting surface 121 is 3.5H.

Regarding to the size of the inputting surface 121, the size of the inputting surface 121 will change the proportion between the light paths L1, L2 and L3. In the present embodiment, the light inputting surface 121 is circle-shaped and a diameter D4 of the inputting surface 121 is 18.5H.

Regarding a distance D5 between the light emitting surface 111 and the inputting surface 121 of lighting component 120, the distance between the light emitting surface 111 and the inputting surface 121 of lighting component 120 will change the position where the light reaches the top outputting surface 122, and therefore results in refraction or total reflection. In the present embodiment, the distance D5 between the light emitting surface 111 and the inputting surface 121 of the lighting component 120 is 1.5H.

Moreover, in the lighting component 120 of the present embodiment, a joint between the top outputting surface 122 and the lateral outputting surface 123 is an arc corner R. The arc corner R can avoid any dark or bright texture resulted at the joint.

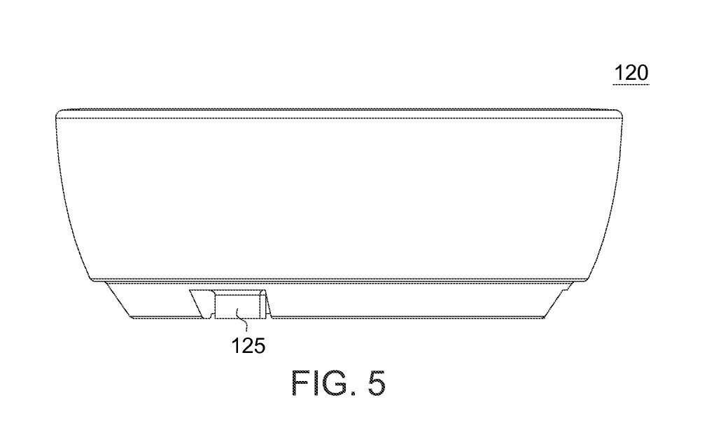

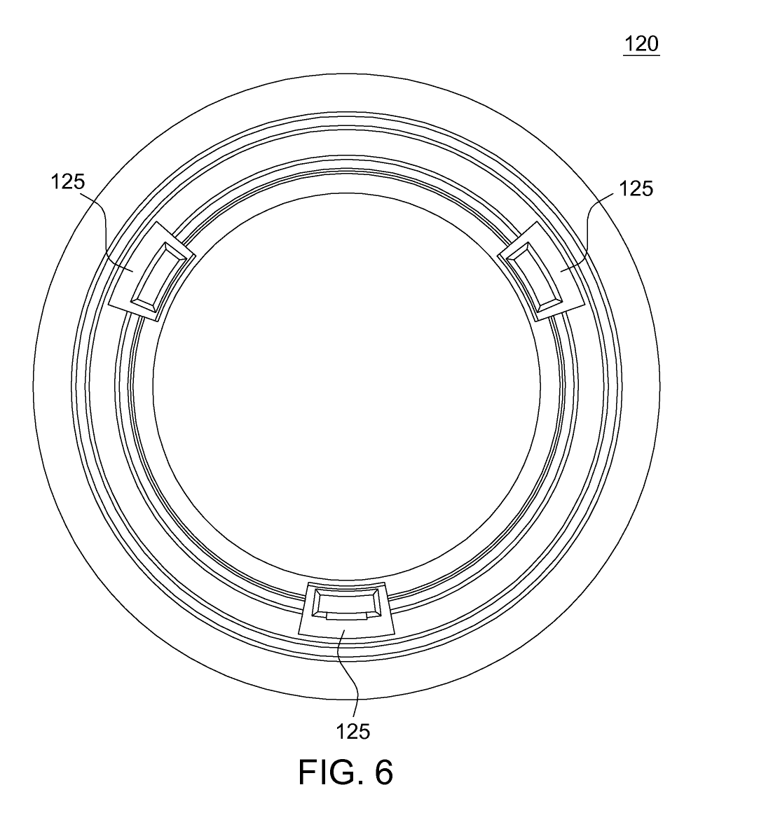

Please referring to FIGS. 5 to 6, FIG. 5 shows a side view of the lighting component 120 of the lighting device 100 of FIG. 1, and FIG. 6 shows a back view of the lighting component 120 of the lighting device 100 of FIG. 1. The lighting component 120 of the present embodiment further comprises three hooks 125. The hooks 125 are disposed at the periphery of the lighting component 120 to lock with a casing body 140 (shown in FIG. 2) for the convenience of assembly.

According to the light device 100 and lighting component 120 disclosed in the above embodiments of the invention, a concave structure 122a of the lighting component 120 is used in a lighting device 100 to emit an omnidirectional light for the need in lighting.

While the disclosure has been described by way of example and in terms of the exemplary preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lighting device, comprising:
a LED module, having an exposed light emitting surface; and
a lighting component, covering the LED module and having an inputting surface and a top outputting surface, wherein the inputting surface faces the light emitting surface of the LED module, the top outputting surface has a concave structure, and the concave structure is located opposite the light emitting surface.

2. The lighting device according to claim 1, wherein the top outputting surface is used for refracting or reflecting a light which enters the lighting component through the inputting surface.

3. The lighting device according to claim 2, wherein a cross-section of the top outputting surface substantially satisfies an equation:
Y=7.984×10⁻⁷X⁶−8.093×10⁻⁵X⁵+3.185×10⁻³X⁴−5.988×10⁻²X³+4.845×10⁻¹X²+2.520×10⁻¹X;
wherein a lowest point of the concave structure is an origin of a X-Y coordinate system, Y is a variable of a vertical axis, X is another variable of a horizontal axis, 0≦X≦15 H, and H is a unit of length.

4. The lighting device according to claim 3, wherein the LED module is circle-shaped and a diameter of the LED module is 9H.

5. The light device according to claim 3, wherein a projection of the top outputting surface toward the inputting surface is circle-shaped and a diameter of the projection is 30H.

6. The light device according to claim 3, wherein the light inputting surface is circle-shaped and a diameter of the inputting surface is 18.5H.

7. The light device according to claim 3, wherein a distance between the light emitting surface of the LED module and the inputting surface of the lighting component is 1.5H.

8. The light device according to claim 3, wherein a distance between the lowest point of the concave structure of the top outputting surface and the inputting surface is 3.5H.

9. The light device according to claim 1, wherein the lighting component further has a lateral outputting surface, the lateral outputting surface is located between the top outputting surface and the inputting surface, and the lateral outputting surface is used for refracting a light reflected from the top outputting surface.

10. The light device according to claim 9, wherein a joint between the top outputting surface and the lateral outputting surface is an arc corner.

11. The light device according to claim 1, wherein the light inputting surface is substantially a flat plane.

12. The light device according to claim 11, further comprising a circuit board, used for disposing the LED module.

13. A lighting component, comprising:
an inputting surface, facing a light emitting surface of a light source;
a top outputting surface, having a concave structure, the concave structure located opposite the light emitting surface; and
a lateral outputting surface, located between the inputting surface and the top outputting surface;
wherein a cross-section of the top outputting surface substantially satisfies an equation:
Y=7.984×10⁻⁷X⁶−8.093×10⁻⁵X⁵+3.185×10⁻³X⁴−5.988×10⁻²X³+4.845×10⁻¹X²+2.520×10⁻¹X;
wherein a lowest point of the concave structure is an origin of a X-Y coordinate system, Y is a variable of a vertical axis, X is another variable of a horizontal axis, 0≦X≦15H, and H is a unit of length.

14. The lighting component for lighting according to claim 13, wherein a projection of the top outputting surface toward the inputting surface is circle-shaped and a diameter of the projection is 30H.

15. The lighting component for lighting according to claim 13, wherein the light inputting surface is circle-shaped and a diameter of the inputting surface is 18.5H.

16. The lighting component for lighting according to claim 13, wherein a distance between the lowest point of the concave structure of the top outputting surface and the inputting surface is 3.5H.

17. The lighting component for lighting according to claim 13, wherein the light inputting surface is substantially a flat plane.

18. The lighting component for light according to claim 17, wherein the top outputting surface is used for refracting and reflecting a light entering the lighting component through the inputting surface of the lighting component.

19. The lighting component for lighting according to claim 18, wherein the lateral outputting surface is used for refracting a light reflected from the top outputting surface.

20. The lighting component for lighting according to claim 19, wherein a joint between the top outputting surface and the lateral outputting surface is an arc corner.
